(19) United States
(12) Patent Application Publication
(10) Pub. No.: US 2025/0249618 A1
(43) Pub. Date: Aug. 7, 2025

(54) SYSTEMS AND METHODS FOR PERFORATING TEXTILES, INCLUDING CARPET AND RUG UNDERLAYMENT

(71) Applicants: John Thompson, Alpharetta, GA (US); Kelsey Finn, Atlanta, GA (US); Samuel Thompson, Atlanta, GA (US)

(72) Inventors: John Thompson, Alpharetta, GA (US); Kelsey Finn, Atlanta, GA (US); Samuel Thompson, Atlanta, GA (US)

(21) Appl. No.: 18/433,282

(22) Filed: Feb. 5, 2024

(51) Int. Cl. B26F 1/20; B26D 7/20

(52) U.S. Cl. CPC B26F 1/20; B26D 7/204; B26F 2210/14

(57) ABSTRACT

Described herein are examples of a perforating device for perforating a textile material, such as carpet or textile underlayment. In an example, the perforating device includes a multi-blade assembly rotationally driven by a motor. The blade assembly can be coupled to a rotary shaft such that the blades rotate with the shaft. The blades can include alternating teeth and gaps on their outer edges to create a plurality of parallel perforated cuts. Spacers can be positioned between the blades to separate them a predetermined distance. An anvil can be positioned below and adjacent the blade edges such that the teeth of the blades touch or nearly touch the anvil surface. The perforating cuts produce a textile that can be customized in terms of its size and shape at an installation site by hand, and without the need for any specialized tools or equipment.

### BACKGROUND

Carpets and rugs installed in homes and businesses are traditionally installed with an underlayment or padding underneath. Carpet and/or rug underlayment provides a non-slip surface, extends the life of the carpet, provides added comfort, and improves the acoustics of a room. Carpet underlayment is generally available in standard sizes or as large sheets or rolls of a predetermined width. As a result, for many rugs and when carpeting rooms, the underlayment must be either custom ordered based on the room size or cut to size on site using specialized equipment.

Neither option is cost effective from the manufacturer's point of view. For example, where underlayment is sold in custom sizes, a manufacturer cannot benefit from the same economies of scale afforded to those manufacturing in standard or bulk sizes. And even the process of manufacturing underlayment in standard sizes suffers from drawbacks associated with the need to reconfigure equipment, store goods of different sizes, and transport products of varying weight and dimensions.

The current systems and methods are also inefficient from a consumer standpoint. Regarding custom-sized underlayment, the additional costs involved in manufacturing, storing, and transporting the goods are passed on to the consumer. Ordering underlayment sold in standard sizes or bulk can be more cost effective on a cost-per-area basis, but such underlayment also has drawbacks and hidden costs. For example, a consumer ordering standard-sized or bulk underlayment generally needs to trim at least some portion of the underlayment from one or more of its sides during the installation process. Trimming the underlayment on site can be difficult and time consuming. Maintaining straight lines with free-hand tools can be a challenge and, depending on the thickness of the underlayment, a consumer may not have a tool at their disposal that is suitable for the job. So while a consumer may be able to save on material costs by ordering underlayment in bulk or a standard size compared to ordering custom, some or all of these saving are often forfeit when installation costs are taken into account.

As a result, a need exists for a way to customize underlayment sizing.

### SUMMARY

Descriptions herein include examples of a perforating device for making perforating cuts in a textile material, such as carpet or rug underlayment. Although carpet underlayment is used throughout as an example of material that can be perforated using the described perforating device, this is not meant to be limiting in any way. For example, the perforating device described herein can be used to make perforating cuts in a variety of textile materials, including but not limited to carpet, rugs, underlayment, flooring substrates, or foam, regardless of whether such material is machine-made, handmade, or formed in some other manner. It should further be understood throughout this disclosure that the terms “textile(s),” “carpet(s),” “rug(s),” “underlayment(s),” and “substrate(s)” are used interchangeably and are only illustrative of materials that can be perforated and formed using embodiments of the described systems and methods.

In an example, a perforating device can include a blade assembly with multiple, annular blades. The annular blades can be axially aligned with, and coupled to, a shaft that can be coupled to a motor that drives rotation of the shaft and the annular blades. In another aspect, the annular blades are separated a predetermined distance from each other by spacers. The blades include alternating teeth and gaps so that, when rotated, the spaced annular blades can make a plurality of parallel perforating cuts (i.e., a series of cuts separated by uncut spaces) in the material.

In a further aspect, a rotating cylindrical anvil can be positioned directly adjacent the blades so that the outer edge of the teeth of the blades in the blade assembly contact the outer surface of the cylindrical anvil when rotating. In one example, the axial length of the cylindrical anvil is substantially the same or slightly longer than the axial length of the shaft of the blade assembly. In another example, the axis of the anvil can be located substantially parallel to the shaft of the blade assembly. In further examples, like the blade assembly, rotation of the anvil can be driven by a motor (e.g., either the same motor that drives rotation of the blade assembly or a second motor). In another aspect, the anvil is driven in the opposite rotational direction from that of the blades of the blade assembly.

In some examples, the perforating device can include a support surface, such as a flat table-like surface, that the material can be placed on while making perforating cuts. In one aspect, the plane of the support surface extends between the blade assembly and the anvil. In a further example, the support surface includes an opening below the blade assembly and above the anvil such that the support surface does not interfere with the contact between the blade assembly and the anvil.

In another aspect, while the motor is running, the material can be fed along the support surface and between the blade assembly and the anvil. The alternating tooth/gap configuration of the annular blades can cause the blade teeth to make cuts in the material, but leave alternating portions of the material attached based on the blade gap locations. The rotating blade assembly teeth and anvil can also serve to pull the material through the perforating device while the device makes its perforating cuts.

The perforating device can also include other features. For example, the support surface of the perforating device can be mounted to an adjustable stand that can be used to adjust the height of the support surface, the blade assembly, or both. The perforating device can further include a guard located around the blade assembly that protects users from injury by preventing any contact with the blades. The perforating device can further include a mechanism, such as a fulcrum, for raising and lowering the blade assembly relative to the support surface.

A method is also provided for perforating a textile material, such as carpet underlayment. The method includes providing the aforementioned perforating device, including a rotating blade assembly and anvil, located above and below, respectively, a support surface. In use, the textile material can be placed on the support surface and guided between the blade assembly and the anvil. As the textile passes between the blade assembly and the anvil, the blades of the blade assembly can make a plurality of parallel perforating cuts in the textile material. In another aspect, the rotation of the blade assembly and anvil can also serve to pull the textile across the support surface and guide a length of the textile through the perforating device.

Both the foregoing general description and the following detailed description are exemplary and explanatory only and are not restrictive of the examples, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustration of a perspective view of an example perforating device;

FIG. 2 is an illustration of an aerial view of an example perforating device;

FIG. 3 is an illustration of a front view of an example perforating device;

FIG. 4 is an illustration of an exploded view of an example blade assembly of a perforating device;

FIG. 5 is an illustration of a cross-sectional view of an example blade;

FIG. 6 is an illustration of an example blade assembly of a perforating device; and

FIGS. 7A and 7B are illustrations of example textile materials with perforating cuts.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Described herein are examples of a perforating device for perforating carpet underlayment and other textile material. In an example, the perforating device can include a support surface, a guide plate, a blade assembly, and a cylindrical anvil. In some embodiments, the blade assembly can include multiple annular blades mounted to a rotary shaft such that the blades rotate with the shaft. In further embodiments, the blades are separated from one another along the axial extension of the rotary shaft by spacers that separate the blades a predetermined distance. In some examples, the blades of the blade assembly can include alternating teeth and gaps along their outer edges.

In another aspect, the cylindrical anvil can be positioned substantially below the blade assembly such that the outer edge of the anvil is located adjacent the outer edge of the blades such that the teeth of the blades can touch or nearly touch the anvil surface.

In a further aspect, the rotary shaft and/or the anvil can be rotationally driven by one or more motors. In such a configuration, when a textile material or carpet underlayment is passed between the blade assembly and the anvil, the blade assembly can make a plurality of parallel perforating cuts in the material. In particular, the number of parallel perforating cuts in the material can correspond with the number of annular blades mounted within the blade assembly and the space between each of the parallel cuts can correspond with the space between each of the annular blades.

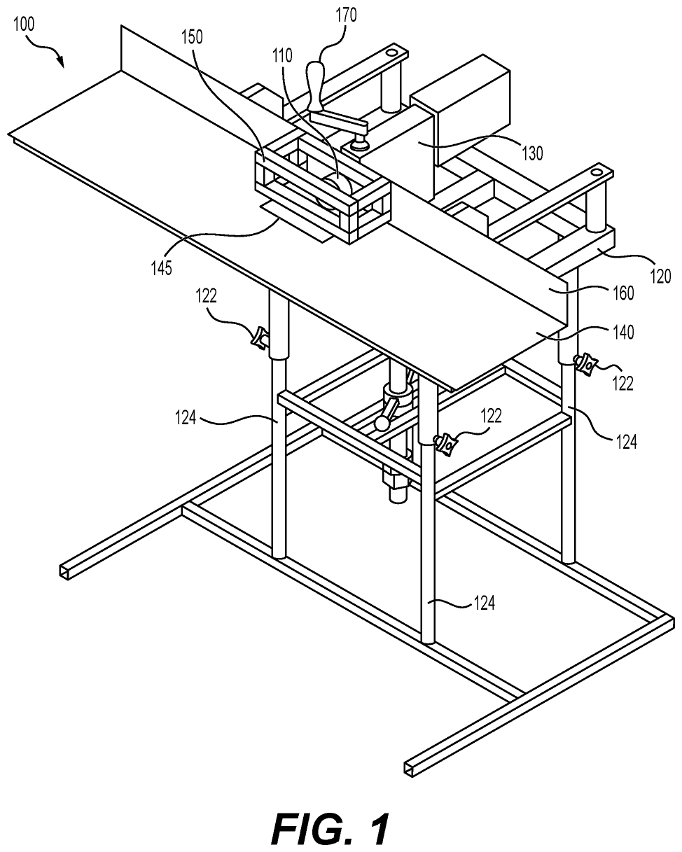

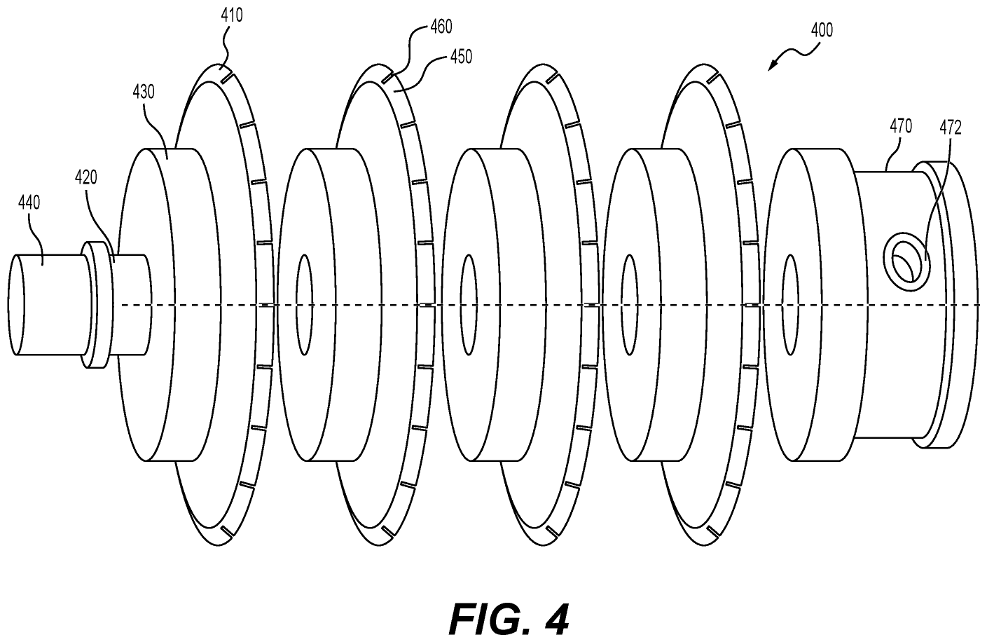

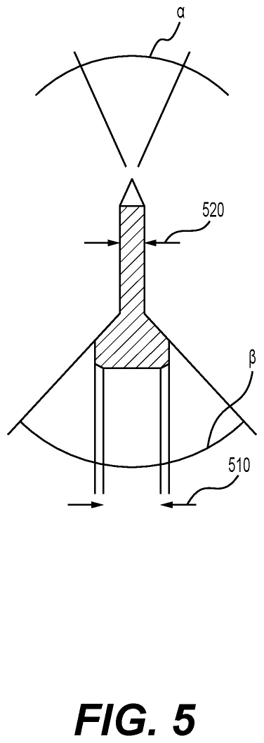

FIG. 1 is an illustration of a perspective view of an example perforating device 100 for making a plurality of parallel perforating cuts in a textile material, such as carpet underlayment. In one aspect, the perforating device 100 can include a blade assembly 110. The blade assembly 110, which is illustrated in greater detail in FIGS. 4 and 5, can include multiple crush slit, annular perforating blades (referred to hereinafter as simply the “blades”). The blades can be made from any suitable material capable of cutting through textile material. For example the blades can be formed from a hardened steel or any other suitable metal or composite material. In further embodiments, and as explained below, the outer edge of the blades comprises alternating teeth and gaps for making perforating cuts in a textile material.

In another aspect, the annular blades can be mounted along a shaft such that each blade is axially aligned with the others. In a further aspect, the blades can be separated from one another along the axial extension of the shaft by a number of annular spacers. In some embodiments, a proximal end of the shaft can be mounted to a motor 130 that imparts rotational movement to the shaft. The blades and spacers can be placed along the shaft in an alternating fashion until the shaft terminates at a distal end located away from motor 130.

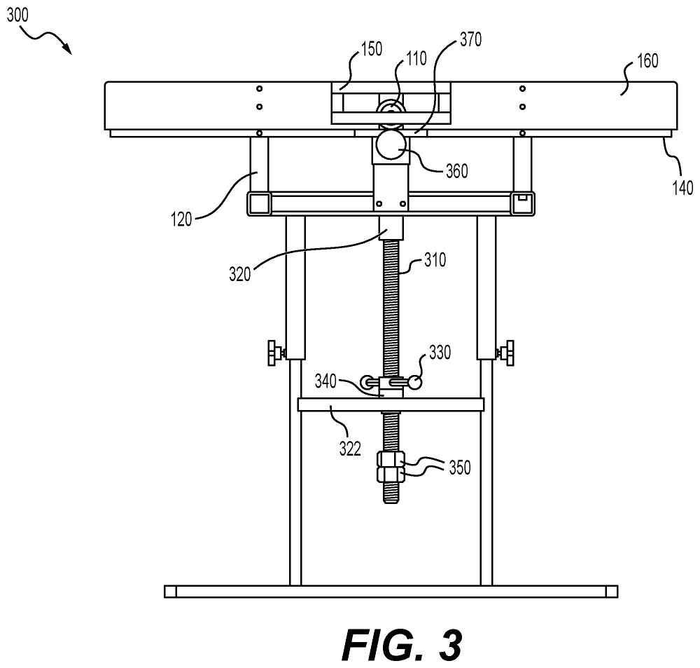

Perforating device 100 can also comprise a cylindrical anvil 360 (not visible in FIG. 1 but depicted in FIGS. 3 and 5). In some embodiments, cylindrical anvil 360 can be located substantially below blade assembly 110. In further embodiments, cylindrical anvil 360 is located such that its outer edge is in contact with the outer edge of the blades of blade assembly 110. For example, anvil 360 and blade assembly 110 can be positioned such that the two components share a common point of tangency between them. Like the shaft of blade assembly 110, cylindrical anvil 360 can be mounted on a shaft that is coupled to a motor for imparting rotational movement to anvil 360. In some embodiments, anvil 360 and blade assembly 110 can both be coupled to the same motor 130. Alternatively, anvil 360 and blade assembly 110 can each be coupled to their own independent motor. In either case, in further embodiments, the shaft of blade assembly 110 and the shaft of cylindrical anvil 360 can be rotated in opposite directions so as to impart a linear movement to a textile fed between the two components, as further described below. For the purposes of this disclosure, reference will only be made to a motor 130 for imparting rotational movement to both blade assembly 110 and anvil 360. However, it should be appreciated that reference to motor 130 includes embodiments comprising two motors, one coupled to blade assembly 110 and one coupled to anvil 360.

In another aspect, perforating device 100 can include a support surface 140 that a textile material, or a portion thereof, can lay on for support while the material is being perforated. In some embodiments, support surface 140 lies in a plane extending substantially parallel to the ground and passing through the common point of tangency between blade assembly 110 and anvil 360. In further embodiments, and so as not to interfere with the contact between blade assembly 110 and anvil 360, support surface 140 can include an opening 145 located below blade assembly 110 and above anvil 360. The length and width of support surface 140 can be any suitable size for supporting a textile. In some embodiments, support surface 140 can be approximately six feet in length and approximately two feet wide. However, in other embodiments, support surface 140 can be longer, shorter, thinner, or wider.

In a further aspect, perforating device 100 can also include a back guard 160. Back guard 160 can comprise a flat surface positioned perpendicular to support surface 140 and extending upward from support surface 140 at the proximal end of the shaft of blade assembly 110. In some embodiments, back guard 160 can extend three to six inches above support surface 140. In other embodiments, back guard 160 can be shorter or taller.

In use, a sheet of textile material, or a portion thereof, can be placed on support surface 140. In some examples, a user may desire to make a plurality of parallel perforating cuts along a first edge of the material. To perform such cuts the user can situate the textile on support surface 140 with the first edge of the material abutting back guard 160. In further examples, the textile can then be moved toward blade assembly 110 and anvil 360 until the top surface of the textile comes in contact with the outer edge of the annular blades of assembly 110 and the bottom surface of the textile comes in contact with the outer surface of cylindrical anvil 360.

In one aspect, and because the blade assembly 110 and anvil 360 are rotating in opposite directions, the friction between the teeth of the annular blades of blade assembly 110 and the top surface of the textile, and the friction between anvil 360 and the bottom surface of the textile serve to advance the first edge of the textile across support surface 140 along the extension of back guard 160. In a further aspect, and to the extent friction alone imparted by the rotating blade assembly and anvil are insufficient to advance the material across support surface 140, the user can also guide the material across the support table by hand.

In another aspect, back guard 160 can aid in keeping the material properly aligned with blade assembly 110 while the plurality of parallel perforating cuts are made. The first edge of the material can be fed between blade assembly 110 and anvil 360 for its entire length or for any portion thereof that the user desires to make the perforating cuts.

In some embodiments, perforating device 100 can optionally include a safety guard 150 located around blade assembly 110. Safety guard 150 can comprise a number of vertical and horizontal members so as to form a “cage” or similar structure around blade assembly 110 such that a user is protected from injury, i.e., the user's fingers or hands cannot inadvertently contact the blades of blade assembly 110 when the device is in use. In a further embodiment, safety guard 150 can be mounted to back guard 160 in such a way that the guard is suspended above, or not in direct contact with, support surface 140. For example, back guard 160 can be mounted to back guard 160 in such a way that a gap exists between the bottom surface of back guard 160 and the top surface of support surface 140 that is sufficient to allow a textile material, such as underlayment, to pass between safety guard 150 and support surface 140. In this way, the material can be passed between blade assembly 110 and anvil 360 without interference from safety guard 150.

In another aspect, one or more of the aforementioned components of perforating device 100 can be supported by a stand 120. Stand 120 can be any structure that sufficiently supports one or more of blade assembly 110, anvil 360, motor 130, support surface 140, back guard 160, and safety guard 150. Stand 120 can be made of any suitable material, including metals, such as aluminum or steel, plastics, or composites. In a further aspect, the height of stand 120 can be adjustable so that the height at which a material is perforated can be changed based on space limitations and/or the comfort of a user. For example, stand 120 can include a plurality of legs 124, each comprising two or more nested elongate members that can slide with respect to one another. In some embodiments, adjustment knobs 122 can include threaded shafts that screw into an outer elongate member of legs 124 and exert a force on an inner elongate member of legs 124 nested within the outer elongate member. In this way, the relative position of the inner member with respect to the outer member is fixed, preventing the inner and outer members from sliding relative to each other. A user can unscrew or loosen knobs 122, slide the outer or inner member with respect to the other, and then retighten knobs 122 in order to adjust the height of legs 124. In an alternative embodiment, the inner member can include a series of vertically arranged predrilled holes, and knobs 122 can be secured to the outer members with a spring so that a user can pull knobs 122 to disengage it from one hole of an inner member, slide the inner member relative to the outer member, and then release knob 122 such that it engages with a different hole in the inner member. Of course, the mechanisms for adjusting the height of perforating device 100 described here are only illustrative. In other embodiments, any appropriate height adjustment mechanism can be used to adjust the length of legs 124. In still further embodiments, legs 124 can comprise casters or wheels at their ends proximate the ground. In such examples, perforating device 100 can be portable and/or easily moved within a workspace.

In another aspect, perforating device 100 can include a blade height adjustment mechanism 170 for adjusting the amount of space between blade assembly 110 and support surface 140 and/or anvil 360. For example, blade assembly 110 can be lowered for cutting textile material and raised to disengage blade assembly 110. In another example, if a material gets caught or snagged in blade assembly 110, a user can use adjustment mechanism 170 to raise blade assembly 110 so that the material can be freed. In further examples, the height of blade assembly 110 can be adjusted based on the type of material being cut. For example, the space or gap desired between blade assembly and support surface 140 and/or anvil 360 may be relatively small for some thinner materials and relatively large for some thicker materials.

In some embodiments, blade height adjustment mechanism 170 can comprise a rotating handle coupled to a threaded elongate member coupled to a gear mounted to blade assembly 110. In use, the handle can be turned clockwise or counterclockwise to cause the elongate member to move up or down with respect to the gear. It should be appreciated, however, that the mechanism(s) for adjusting the space between blade assembly 110 and support surface 140 and/or anvil 360 described here are only illustrative. In other embodiments, any appropriate blade height adjustment mechanism 170 can be used for manipulating the space or gap between blade assembly 110 and support surface 140 and/or anvil 360, including but not limited to any suitable mechanical means, electronic means, or some combination of the two.

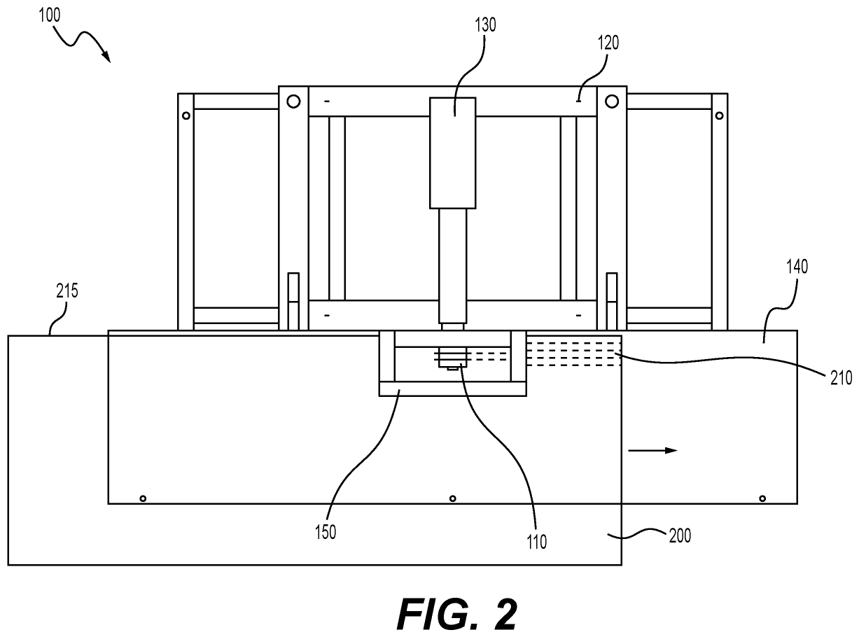

FIG. 2 is an illustration of an aerial view of perforating device 100 as it makes a plurality of parallel perforating cuts 210 in a textile material 200. Material 200 can be of any suitable dimension. For example, material 200 can be one of any standard sizes for sheets of textiles (e.g., underlayment) or a portion of a larger roll of textile material (not shown). As depicted in FIG. 2, perforating cuts 210 are being made along edge 215 of material 200. To make perforating cuts 210, and as described above with respect to FIG. 1, a user can place all or a portion of material 200 atop support surface 140 such that edge 215 of material 200 abuts back guard 160 (shown more clearly in FIG. 1).

In some embodiments, motor 130 can be activated so that blade assembly 110 and/or anvil 360 (not shown) rotate. In particular, in embodiments where both blade assembly 110 and anvil 360 are rotating, these two components can rotate in opposite directions such that friction created between them and the top and bottom surfaces of material 200, respectively, facilitate advancement of material 200 across blade assembly 110 in a common feed direction.

In use, edge 215 of material 200 can be guided across the surface of support surface 140 and inserted between the blades of blade assembly 110 and anvil 360. In some embodiments, the blades of blade assembly 110 can be positioned close enough to the surface 140 and/or anvil 360 so that the teeth of the blades can cut through the thickness of material 200 and contact the outer surface of cylindrical anvil 360. In an alternative embodiment, rather than support surface 140 having an opening 145 through which the blades of blade assembly 110 contact anvil 360, support surface 140 can be a solid surface and anvil 360 can be omitted. In such an embodiment, it is the portion of the support surface 140 in contact with the outer edge of the blades of blade assembly 110 that supports material 200 at the point of cutting as opposed to anvil 360.

In one aspect, as material 200 is slid across support surface 140, contact between edge 215 and back guard 160 can be maintained. In this way, blade assembly 110 can make straight and consistent perforating cuts 210 through material 200.

In another aspect, the number of parallel perforating cuts made in material 200 as it passes below blade assembly 110 can correspond to the number of annular blades mounted within blade assembly 110. FIG. 2 depicts an embodiment in which four annular blades are mounted within blade assembly 110. As material 200 passes between blade assembly 110 and anvil 360 (or support surface 140 in alternative embodiments), blade assembly 110 makes four parallel perforating cuts 210 in material 200. It should be appreciated, however, that additional or fewer perforating cuts can be made by increasing or decreasing, respectively, the number of annular blades within blade assembly 110. Similarly, the spacing or gaps between neighboring perforating cuts can be adjusted based on the width of the spacers positioned between each of the annular blades (as described in more detail below).

In a further aspect, the shaft of blade assembly 110, on which a plurality of annular blades and spacers are mounted, can be interchangeable with other shafts on which a different number of annular blades and/or spacers of a different width are mounted. In this way, a user can quickly reconfigure perforating device 100 to make more or fewer perforating cuts, or to change the spacing between the perforating cuts, by quickly swapping out one shaft of blade assembly 110 for another. In another aspect, such interchangeable shafts (on which blades and spacers are pre-mounted) can reduce the time and complexity of device maintenance and repair. For example, when one or more blades of blade assembly is damaged or reaches its end of life based on wear and tear, the shaft can be removed from blade assembly 110 and a new shaft with new blades and spacers can be quickly substituted.

In alternative embodiments, however, blade repair and maintenance can be performed on an individual basis. In such embodiments, when one or more blades of blade assembly is damaged or reaches its end of life based on wear and tear, a user can remove the affected blade(s) and replace them with a new blade without removing the shaft, spacers, or unaffected blade(s) from blade assembly 110.

In another aspect, while FIG. 2 depicts blade assembly 110 extending over a relatively short portion of the overall width of material 200, as measured from the assembly's proximal end to its distal end, this is only illustrative of some embodiments. In alternative embodiments, the shaft of blade assembly 110 may extend over a greater portion, or all, of material 200's width and include many more annular blades. In other words, while the embodiment depicted in FIG. 2 is configured to make four parallel perforating cuts in material 200, perforating device 100 could be configured with a blade assembly having a longer shaft extending the entire width of material 200 such that parallel perforating cuts, spaced one from another any suitable distance, can be made across the entire width of material 200 or any portion thereof. In further examples, where blade assembly 110 contains a relatively long shaft extending over a larger portion, or all, of the width of material 200, it may be necessary or desirable to introduce a support structure at the distal end of blade assembly 110 that allows the blades of blade assembly 110 to maintain a consistent distance from support surface 140 and/or anvil 360. In such embodiments, blade assembly can optionally include a motor 130 at each end of its shaft.

FIG. 3 is an illustration of a front view of a perforating device 300. In one aspect, perforating device 300 includes an alternative blade height adjustment mechanism as compared to adjustment mechanism 170 shown in FIGS. 1 and 2. In some examples, perforating device 300 includes a threaded shaft 310 that extends downward in a direction substantially perpendicular to the blade-carrying shaft of blade assembly 110. In further embodiments, an uppermost end of shaft 310 can be mounted to blade assembly 110 through a housing 320. A distal or lowermost end of housing 320 can include a downward facing opening with female threading for receiving the uppermost (proximal) end of shaft 310. Housing 320 can further contain a toothed rod that mates with the threads of shaft 310 and is connected at its uppermost (proximal) end to blade assembly 110. In such embodiments, rotation of shaft 310 clockwise or counterclockwise can result in the lowering or raising of the toothed rod and, by extension, blade assembly 110. In this way, the height of blade assembly 110 can be adjusted relative to support surface 140 and/or anvil 360.

In another aspect, a collar 330 and securing nut 340, each of which are annular in shape and include female threading, can be mated to shaft 310. In some embodiments, collar 330 includes one or more radially extending handles to facilitate rotation by a user. In such examples, collar 330 can be screwed onto shaft 310 to a suitable height. Securing nut 340 can then be screwed onto shaft 310 until it abuts collar 330 and “locks” it into place. In this way, further rotation of collar 330 using its radially extending handles can rotate shaft 310 as opposed to simply rotating collar 330 along the axial extension of shaft 310. As a result, turning of collar 330 can cause shaft 310 to traverse along the toothed rod within housing 320, thereby adjusting the height of blade assembly 110. Threaded shaft 310 can extend through a hole in a securing plate 322. Collar 330 and securing nut 340 can be positioned on the threaded shaft 310 above the securing plate 322. One or multiple anchoring nuts 350 can be positioned below the securing plate 322. The anchoring nuts 350 can be positioned on the threaded shaft 310 to limit the height to which the blade assembly 110 can be raised.

FIG. 3 further depicts an example of anvil 360 described above with respect to example embodiments. As described previously, anvil 360 can be cylindrical in shape and mounted on a shaft such that it can rotate along an axis substantially parallel to the shaft of blade assembly 110. In one aspect, support surface 140 can include an opening 370 at a location coinciding with blade assembly 110 and anvil 360 such that support surface 140 does not interfere with the interface between blade assembly 110 and anvil 360. Further, anvil 360 can be positioned at a height such that its outermost edge, at the top of its rotation, passes through the plane of support surface 140. In this manner, a textile traversing the perforating device is always supported either by support surface 140 or anvil 360.

In some examples, when perforating device 300 is configured for use, the outermost edges of the blades within blade assembly 110 can contact or nearly contact the outermost surface of anvil 360. In such embodiments, anvil 360 can serve as a resistance surface against which the blades of blade assembly 110 press a textile material in order to cut the material. In a further aspect, and as described above with respect to other embodiments, rotation of anvil 360 in a direction counter to the rotation of blade assembly 110 facilitates linear movement of the textile material across blade assembly 110.

In some examples, anvil 360 can be made of hardened steel or any suitable material. In further embodiments, anvil 360 can be made of a material that is not as hard as the blades of blade assembly 110. In this way, anvil 360 can wear out more quickly than the blades of blade assembly 110, as it is more cost effective to replace anvil 360 than the blades of blade assembly 110. In a further aspect, the axial extension (or length) of anvil 360 can be substantially similar to the axial extension (or length) of the shaft of blade assembly 110. As such, anywhere a blade may be mounted to the shaft of blade assembly 110, the outermost edge of the blade teeth can make contact with anvil 360. In alternative embodiments, where the blade assembly is interchangeable with blade assemblies having a different number of blades or different spacing between blades, anvil 360 may likewise be interchangeable such that a user can always match the length of the blade assembly (as measured in the axial direction of its shaft) to the length of the anvil (measured in the same direction).

FIG. 4 is an illustration of an exploded view of an example blade assembly 400 for use in a perforating device. In some examples, blade assembly 400 can correspond to the blade assemblies described previously herein, such as blade assembly 110. Blade assembly 400 includes multiple annular blades 410 that are axially aligned along a shaft 420 (shown only at the distal end of the blade assembly for clarity) and coupled to shaft 420 so that blades 410 can rotate with shaft 420. In some embodiments, blades 410 can mate with shaft 420 in a way that prevents the blades from rotating with respect to shaft 420. For example, the inner opening of blades 410 can include teeth, such as gear teeth, that can mate with gear teeth on the outer surface of shaft 420. Alternatively, the inner opening of blades 410 can include a tongue that extends radially inward toward the center of the annular blades, and shaft 420 can include a corresponding notch such that the tongue of blades 410 must mate with the notch of shaft 420 in order to mount blades 410 on shaft 420. It should be noted, however, that these examples are only illustrative of a few possibilities. Any suitable manner of mounting blades 410 on shaft 420 such that the blades rotate with the shaft as opposed to rotating with respect to the shaft could be implemented.

In one aspect, annular blades 410 can include alternating teeth 450 and gaps 460 around their outer circumference. In some embodiments, teeth 450 can be used to cut through a textile material and gaps 460 can create “ties” (i.e., gaps between the cuts) that keep the cut material attached. In this way, the alternating cuts and ties formed by teeth 450 and gaps 460 of blades 410 make perforations in the textile material.

In another aspect, blades 410 can be made from any suitable material capable of cutting through a textile material. For example, blades 410 can be formed from hardened steel or some other suitable metal, mineral, or composite. In some examples, blades 410 comprise a material having a 58-60HRC hardness, though this is only illustrative of some possibilities and other materials or hardness could be used.

In some embodiments, the height of teeth 450 (measured in the radial direction of annular blades 410) can be selected based on the thickness of a textile to be cut. Alternatively, the height of teeth 450 can be any suitable height needed to cut standard thicknesses of textiles and/or textiles of some predetermined thickness. In another aspect, the length of the teeth 450 and gaps 460 as measured along the outer circumference of annular blades 410 can be selected based on manufacturer specifications and/or the material being cut. For example, for some carpet underlayment, the length of teeth 450 can be approximately 6.5 millimeters and the length of gaps 460 can be approximately one millimeter. In an alternative example, the length of teeth 450 can be approximately 8.75 millimeters and the length of gaps 460 can be approximately 0.75 millimeters. In other examples, however, where a textile material may be thinner or easier for a user to pull any ties apart, the length of teeth 450 may be shorter or the length of gaps 460 may be longer (again, both as measured around the circumference of blades 410). Of course, these dimensions are only illustrative of some possibilities and any suitable length for teeth 450 and/or gaps 460 can be used.

In further examples, blades 410 can have a specific geometry for efficiently cutting material while retaining a sharp edge for as much wear life as possible. In one illustrative example, blades 410 can have an outer diameter of approximately 63.5 millimeters and an inner diameter of approximately 31.8 millimeters. Of course, blades having greater or smaller outer and inner diameters can also be suitable.

FIG. 5 depicts a cross section of a portion of blade 410. In one example, blades 410 can also have a hub thickness 510 (i.e., a thickness proximate the blade's inner diameter) of approximately 6.1 millimeters and a blade thickness 520 (i.e., a thickness at the base of the blade edge proximate the blade hub) of approximately 2 millimeters. In another aspect, teeth 450 of blade 410 can comprise a blade tooth angle α of approximately 48 degrees and/or a hub/tooth tapering angle β of approximately 85 degrees. As discussed previously with respect to other blade dimensions, however, these blade tooth and hub/tooth tapering angles are only illustrative of a couple possibilities and any suitable angles can be used.

Returning to FIG. 4, in a further aspect, while four annular blades 410 are depicted, it should be appreciated that more or fewer blades can be used within a blade assembly. For example, the number of blades 410 can be selected based on the number of parallel perforating cuts that a user desires to make in a textile material. In examples where a user desires to make more than four cuts, additional blades 410 can be added and, when necessary, a longer shaft 420 can be used.

In another aspect, blades 410 can be spaced apart along the axial extension of shaft 420 by a plurality of annular spacers 430. The spacers 430 can be of a predetermined thickness based on the desired width between the plurality of parallel perforation cuts to be made in the material. For example, spacers 430 that are an inch, a half-inch, or a quarter-inch wide (as measured in the axial direction of shaft 420) can be used where an inch, half-inch, or quarter-inch gap, respectively, is desired between the parallel cuts. In a further aspect, one or more of the spacers can be of varying width. For example, perhaps a user desires that the parallel cuts are spaced progressively closer and closer together in a direction away from the outer edge of a textile material. In such an example, wider spacers can be used at the proximal end of shaft 420 and progressively narrower spacers can be alternatingly added to shaft 420 between each blade 410. Of course, this is only illustrative of one possibility and, in use, spacers of any width can be used on either side of any of blades 410.

In another aspect, spacers 430 can be made of any material that maintains its shape and can withstand any torque applied by the blades 410. For example, spacers 430 can be made of any suitable plastic, metal, or composite material. In some embodiments, spacers 430 can be made of a plastic or composite designed to absorb vibrations of blades 410 in order to extend the life of the blades and/or reduce noise produced by the perforating device when it is in use.

In further examples, the center opening of annular spacers 430 can be shaped such that spacers 430 can move and/or rotate freely along shaft 420. Alternatively, spacers 430 can be mounted to shaft 420 in a manner similar to that described above with respect to blades 410, such that spacers 430 rotate with shaft 420 and cannot rotate with respect to shaft 420. In yet another alternative embodiment, spacers 430 can be provided integral to blades 410 such that a user selects a blade/spacer combination to mount on shaft 420 based on the qualities of the blade and/or spacer.

In some examples, blade assembly 400 can further include an end cap 440 that can be placed at the distal end of shaft 420 for securing blades 410 and spacers 430 on the shaft. In some embodiments, end cap 440 can be any securing mechanism that secures the blades 410 and spacers 430 on the shaft 420. For example, end cap 440 can include female threading for screwing end cap 440 onto a male threaded distal end of shaft 420. In another example, end cap 440 can be substituted for a cotter pin that can be inserted into holes located at the distal end of shaft 420.

In another aspect, an annular collar 470 can be provided for receiving a proximal end of shaft 420. In some embodiments, collar 470 can be coupled to a motor (such as motor 130 of FIG. 1) for imparting rotational movement to collar 470. In particular, collar 470 can be configured to receive the proximal end of shaft 420 in a way that ensures shaft 420 rotates with collar 470 as opposed to allowing shaft 420 to rotate with respect to collar 470. In some embodiments, this can be achieved using any of the techniques described above with respect to mounting blades 410 and/or spacers 430 to shaft 420. In other embodiments, collar 470 may include a female threaded aperture 472 for receiving a set screw (not shown). In such embodiments, the proximal end of shaft 420 can be positioned inside the center opening of annular collar 470 and the set screw can be tightened until sufficient pressure is applied to shaft 420 to retain the shaft and prevent it from rotating with respect to collar 470. In further examples, shaft 420 can include its own female threaded aperture for receiving the distal end of the set screw. In this way, not only is shaft 420 mounted within collar 470 such that the shaft rotates with the collar, but shaft 420 is also fixed in place in its axial direction with respect to collar 470 such that it cannot be removed from collar 470 without first removing the set screw.

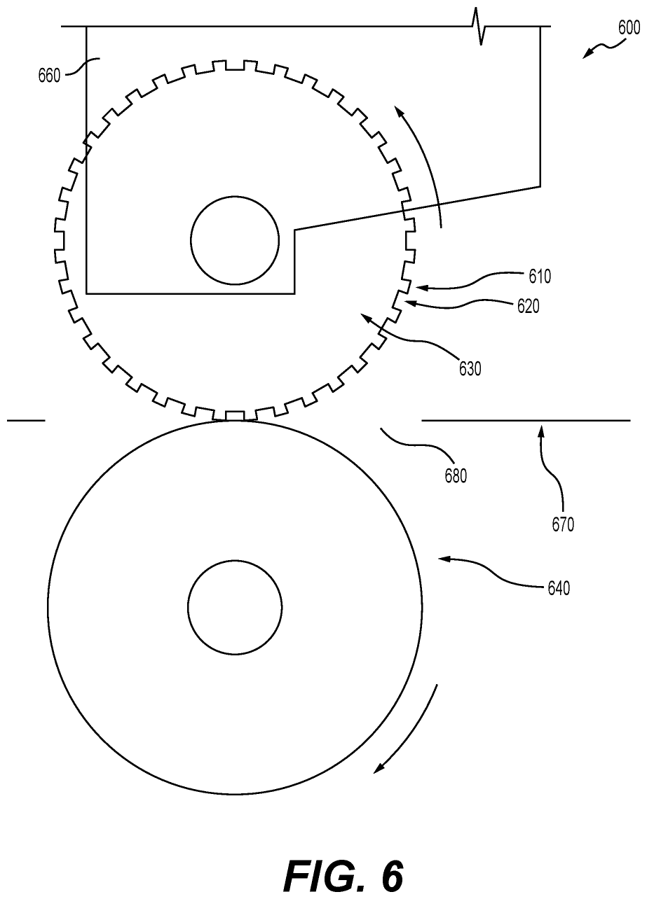

FIG. 6 is an illustration of a cross-sectional view of a blade assembly 600 and corresponding cylindrical anvil 640 of a perforating device. Blade assembly 600 can correspond to the blade assemblies described previously herein, such as the blade assemblies 110 and 400. In one aspect, blade assembly 600 includes annular blades 630 comprising teeth 610 that are separated by gaps 620. Anvil 640 can, for example, correspond to anvil 360 in FIG. 3. As described previously, the hardness of blades 630 can be formed from a harder material than anvil 640 such that anvil 640 wears faster than blades 630.

In another aspect, both blades 630 and anvil 640 can be rotationally driven by one or more motors. As shown in FIG. 6, in some embodiments and when in use, blades 630 can be rotationally driven in one direction (e.g., counterclockwise) while anvil 640 can be rotationally driven in an opposite direction (e.g., clockwise). In this way, as a textile material is fed across support surface 670 from, for example, left to right, the frictional forces resulting from the counter-rotations of blades 630 and anvil 640 can serve to facilitate continued movement of the textile in the feed direction (i.e., in the depicted example, left to right).

In a further aspect, support surface 670 is located co-planar with a common point of tangency located at the point of contact between the outer edge of blades 630 and the outer edge of anvil 640. Support surface 670 can further comprise an opening 680 around the interface of the blades and the anvil (i.e., around the common point of tangency) such that, as a textile material passes between blades 630 and anvil 640, direct contact can be made between the blades and anvil through the textile and without interference from support surface 670. In such embodiments, support surface 670 can support portions of a textile material that have been cut as well as portions of the textile material that have yet to be cut, both at substantially the same height that the textile is supported by anvil 640 when being cut. In this way, a smooth feed of the textile material can be facilitated by avoiding any vertical displacements (i.e., height variations) to the textile as it is fed across support surface 670, between blades 630 and anvil 640, and back onto support surface 670.

In another aspect, blade assembly 600 can optionally include a safety guard 660 comprising a combination of members forming an enclosure around blade assembly 600 for protecting users from injury when using the perforating device. In some embodiments, safety guard 660 can comprise a wire cage or a plexiglass enclosure. In other embodiments, however, safety guard 660 can take the form of any type of enclosure that can prevent or discourage a user from accidentally contacting blades 630 or any moving component of blade assembly 600 with their fingers, hands, or arms.

In use, the one or more motors coupled to blades 630 and anvil 640 can rotate the blades and anvil at any appropriate speed based on the material being perforated and/or the speed at which a user desires to feed a textile material through the perforating device. For example, based in part on the counter-rotation of blades 630 and anvil 640, teeth 610 of blades 630 can catch and pull the material between the blades 630 and the anvil 640, advancing the material across support surface 670. Teeth 610 can cut through the material and gaps 620 can leave ties or uncut portions of material, thereby creating perforations in the textile. In some examples, when blade assembly 600 includes multiple blades 630 separated by spacers (not depicted in the cross-sectional view), as depicted in FIG. 4, blade assembly 600 can simultaneously make a plurality of parallel perforating cuts in the material at predetermined spacing with respect to one another.

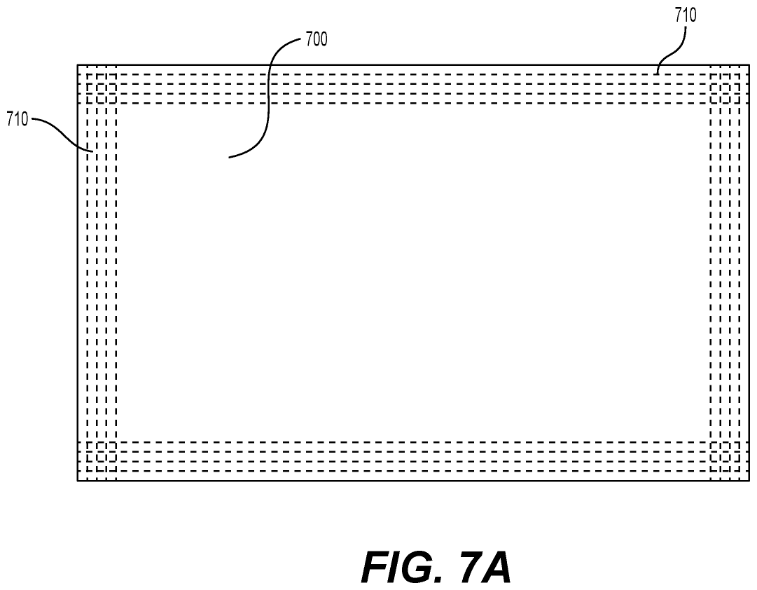

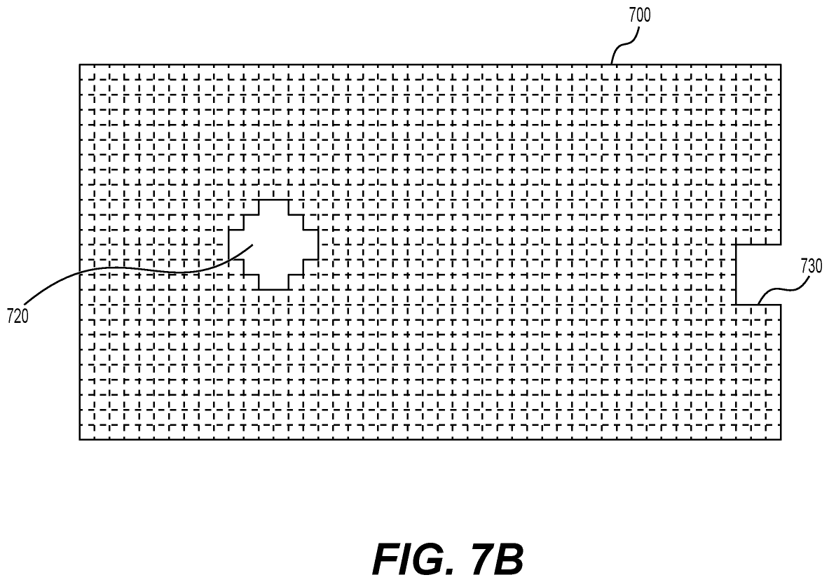

FIGS. 7A and 7B are illustrations of an example textile material 700 comprising perforated cuts 710 made in accordance with this disclosure. Textile material 700 can be of any standard or predetermined size or dimensions. In an example, shown in FIG. 7A, textile material 700 can include multiple, parallel perforated cuts 710 along one or more of edges of the material. In one example, the perforated cuts 710 along each edge can be spaced apart equally with respect to one another. In other embodiments, and as described above, the spacing between parallel perforations can vary based on the size of spacers positioned within the blade assembly.

FIG. 7A depicts an embodiment of a textile having four parallel perforated cuts 710 around each of textile 700's four edges. However, it should be appreciated that this embodiment is illustrative only and textile 700 could comprise any number of perforated cuts 710 across its width, its length, or in any other direction. For example, and as shown in FIG. 7B, by using a blade assembly and anvil comprising a longer axial length, and by adding additional blades to the blade assembly, parallel perforation cuts 710 could be made in textile 700 across its entire width, its entire length, or any portion thereof (see, e.g., FIG. 7B).

In another aspect, perforated textile 700 can be provided to a user at an installation site and the user can easily customize the size of the textile by tearing the textile along any one or more perforated cuts (or portions thereof). In some embodiments, because tearing the textile along its perforated cuts can be accomplished by hand, no tools or instruments are necessary. A user can easily shorten textile 700's width or length by tearing one or more perforated cuts 710 along one or more of the textile's edges.

In further embodiments, where perforated cuts intersect (i.e., cuts across the textile's width intersect with cuts across the textile's length), a user can customize the shape of the textile's edges and/or create customized openings anywhere within the interior of the textile. For example, and as depicted in FIG. 7B, where a room in which a textile is being installed has a free-standing column, a user can tear an opening 720 within textile 700 of any appropriate size and at any desirable location within the textile. In another example, and as also depicted in FIG. 7B, where a room in which a textile is being installed is comprised of walls defining something other than a square or rectangular space, the edges of textile 700 can be customized by tearing portions 730 of perforated cuts 710, but not tearing each cut across its entire length. In a further example, a rectangular textile 700 can be customized at an installation site, and by hand with no specialized tools, to create a substantially circular textile or any other shape.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented is only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as illustrative only, with a true scope and spirit of the disclosure being indicated by the following claims.

What is claimed is:

1. A perforating device, comprising:
a support surface comprising an aperture;
a cylindrical anvil;
a blade assembly, comprising:
a shaft;
a plurality of co-axial annular blades, each of the annular blades coupled to the shaft such that rotation of the shaft rotates the plurality of an annular blades, each annular blade comprising a plurality of alternating teeth and gaps located at the respective annular blade's outer edge;
one or more motors configured to rotate the shaft in a first direction,
wherein an outer surface of the anvil and the outer edge of the annular blades are in contact above, below, or within the aperture of the support surface.

2. The perforating device of claim 1, wherein the anvil is configured to rotate in a second direction opposite the first direction.

3. The perforating device of claim 2, wherein the one or more motors is configured to rotate the anvil.

4. The perforating device of claim 2, wherein an axis of rotation of the shaft and an axis of rotation of the anvil are substantially parallel.

5. The perforating device of claim 1, wherein the annular blades comprise a first material and the anvil comprises a second material, the first material having a greater hardness than the second material.

6. The perforating device of claim 1, further comprising a plurality of spacers coupled to the shaft such that each axially adjacent pair of annular blades are separated by at least one spacer along the axial extension of the shaft.

7. The perforating device of claim 6, wherein each spacer is integral with at least one of the plurality of annular blades.

8. A device for perforating textiles, the device comprising:
a support surface; and
a blade assembly, comprising:
a shaft;
a plurality of co-axial annular blades, each of the annular blades coupled to the shaft such that rotation of the shaft rotates the plurality of an annular blades, each annular blade comprising a plurality of alternating teeth and gaps located at the respective annular blade's outer edge;
one or more motors configured to rotate the shaft in a first direction,
wherein the outer edge of the annular blades have a point of tangency located proximate to the support surface.

9. The device of claim 8, further comprising a guard surface extending above and perpendicular to the support surface.

10. The device of claim 8, wherein a height of the blade assembly with respect to a height of the support surface is adjustable.

11. The device of claim 8, wherein the annular blades comprise a first material and the support surface comprises a second material, the first material having a greater hardness than the second material.

12. The device of claim 8, further comprising a plurality of spacers coupled to the shaft such that each axially adjacent pair of annular blades are separated by at least one spacer along the axial extension of the shaft.

13. The perforating device of claim 12, wherein each spacer is integral with at least one of the plurality of annular blades.

14. The perforating device of claim 8, wherein a rotational speed of the shaft is adjustable.

15. A method for making a plurality of parallel perforating cuts in a textile material, comprising:
positioning a textile material on a support surface, the support surface having an aperture;
feeding at least a portion of a first edge of the textile material across the aperture and between a cylindrical anvil and a blade assembly, the blade assembly comprising:
a shaft; and
a plurality of co-axial annular blades, each of the annular blades coupled to the shaft such that rotation of the shaft rotates the plurality of an annular blades, each annular blade comprising a plurality of alternating teeth and gaps located at the respective annular blade's outer edge;
passing a length of the textile material across the support surface and between the blade assembly and the anvil such that the blade assembly makes a plurality of parallel perforating cuts in the textile material, each perforating cut comprising alternating cuts in, and ties of, the textile material.

16. The method of claim 15, further comprising rotating the shaft of the blade assembly in a first direction and rotating the anvil in a second direction opposite the first direction.

17. The method of claim 16, wherein one or more motors is configured to rotate the shaft of the blade assembly and the anvil.

18. The method of claim 16, wherein an axis of rotation of the shaft and an axis of rotation of the anvil are substantially parallel.

19. The method of claim 15, wherein a rotational speed of the shaft of the blade assembly is approximately equal to a rotational speed of the anvil.

20. The method of claim 15, wherein the annular blades comprise a first material and the anvil comprises a second material, the first material having a greater hardness than the second material.
